(19) United States
(12) Patent Application Publication
(10) Pub. No.: US 2012/0228868 A1
(43) Pub. Date: Sep. 13, 2012

(54) Fireproof bulkhead penetration

(76) Inventor: Trevor Lucey, La Mesa, CA (US)

(21) Appl. No.: 12/925,311

(22) Filed: Oct. 19, 2010

Related U.S. Application Data
(60) Provisional application No. 61/279,375, filed on Oct. 19, 2009.

(51) Int. Cl. F16L 5/00

(52) U.S. Cl. 285/192

(57) ABSTRACT

The present invention provides a better fireproof bulkhead penetration that is substantially less expensive to install and much easier to modify. The bulkhead penetration system is designed to prevent the spread of fire, smoke, water, gas and air through walls or bulkheads in both stationary and marine structures in way of piping and cable penetrations at the fire zone boundaries. Various preferred embodiments meet the requirements of the regulatory authorities having jurisdiction over the structure as well as the requirements of local authorities. In preferred embodiments a high temperature sealant provides an airtight seal for a sleeve type penetration and a high temperature sealant also provides an airtight seal between the sleeve and the bulkhead aperture through which the sleeve passes. The seals can be easily removed for repairs, upgrades and replacements.

### CROSS REFERENCE TO RELATED APPLICATIONS

The present invention claims the benefit of provisional patent Ser. No. 61/279,375 filed Oct. 19, 2009.

### FIELD OF THE INVENTION

This invention relates to wall and deck penetrations and in particular to bulkhead penetrations for pipes and cables for watercraft.

### BACKGROUND OF THE INVENTION

Large ships typically contain many separate compartments. Their separation is needed for many reasons primarily including buoyancy needed in case of structural damage to the ship's hull. Also the separation is required to contain fire in a limited number of compartments. However, many pipes and cables must pass from compartment to compartment. This requires penetrations through the walls of the compartments, referred to as bulkheads. Special penetration systems are in use today to keep fire, smoke and water from passing through the penetrations. U.S. Pat. No. 4,249,353 disclosed a fire barrier assembly for electrical cables that includes a frame and special fit-together plates that fit into the frame and provide apertures sized corresponding to the outer diameters of typical cables. A drawing showing the assembly is shown in FIG. 4. U.S. Pat. No. 4,656,313 discloses a cable penetration seal including packing blocks of deformable material surrounding cables which are compressed to expand then radially to hold the cables in place and create a cavity within the assembly. The cavity is filled with conducting material that prevents the transmission of electromagnetic pulses. Many systems used today require a sleeve to form the boundaries of the penetration through which the cables and pipes pass through the bulkhead. This sleeve is typically welded with a continuous weld on both sides of the bulkhead (see FIGS. 1A-1C). All of the prior art systems described above are very costly to install adding hundreds of thousands to millions of dollars to the cost of a large ocean going ship. Modifications of these penetration systems to change a pipe or cable are also difficult to make.

What is needed is a better fireproof bulkhead penetration that is substantially less expensive to install and much easier to modify.

### SUMMARY OF THE INVENTION

The present invention provides a better fireproof bulkhead penetration that is substantially less expensive to install and much easier to modify. The bulkhead penetration system is designed to prevent the spread of fire, smoke, water, gas and air through walls or bulkheads in both stationary and marine structures in way of piping and cable penetrations at the fire zone boundaries. Various preferred embodiments meet the requirements of the regulatory authorities having jurisdiction over the structure as well as the requirements of local authorities.

The fireproof bulkhead penetration includes a sleeve extending through and fixed to close fitting aperture in the bulkhead, one or more cables and/or pipes extending through the sleeve, a high temperature blanket surrounding the one or more cables and/or pipes, high-temperature sealant seals surrounding the one or more cables and/or pipes at both ends of said sleeve providing an air-tight, gas-tight, smoke-tight and water-tight seal of the sleeve, and high-temperature sealant seals surrounding the sleeve providing an air-tight, gas-tight, smoke-tight and water-tight seal of the bulkhead penetration.

Simplicity and cost effectiveness are the primary advantages of preferred embodiments. These preferred embodiments have only three components—a silicate blanket, a silicone sealant both enclosed in a retaining sleeve. In preferred embodiments, the double continuous weld of the prior art is eliminated when the weld is not required for structural purposes. Fire and water protection can be achieved by various means as shown in the following.

### Preferred Embodiments

Preferred embodiments of the present invention are described in FIGS. 2 and 3.

### Tack Weld System

A tack weld is applied to secure the sleeve to the bulkhead. The rest of boundary is sealed on both sides with a high temperature sealant as shown in FIG. 2.

### Single Sided Weld System

One side of the sleeve is continuously welded and the other sealed by applying a bead(s) of high temperature sealant as shown in FIG. 3.

### Silicate Blanket

A silicate blanket as shown in FIGS. 2 and 3 provides the fire boundary of the penetration while limiting the heat transfer through the penetration.

### High Temperature Silicone Sealant

A high temperature silicone sealant designed to seal the penetration for air, water and gas while withstanding intermittent temperatures reaching up to 300° C. or higher. The sealant remains flexible to facilitate the addition or removal of cable or pipe.

### Advantages Over Prior Art

While other blanket and sealant systems have been in the marketplace for many years what differentiates this system is a) the method of attaching the sleeve to the bulkhead and b) the components used in the proposed system perform at a higher level than those currently available.

### BRIEF DESCRIPTION OF THE DRAWINGS

FIGS. 1A-1C are views of a prior art bulkhead penetration having continuous welds on both sides of the bulkhead all around the penetration sleeve.

FIGS. 2A-2C are views of a bulkhead penetration showing features of a first preferred embodiment of the present invention.

FIGS. 3A-3C are views of a bulkhead penetration showing features of a second preferred embodiment of the present invention.

FIGS. 4 and 5 are a drawings showing a bulkhead penetration from a prior art patents.

### DETAILED DESCRIPTION OF PREFERRED EMBODIMENTS

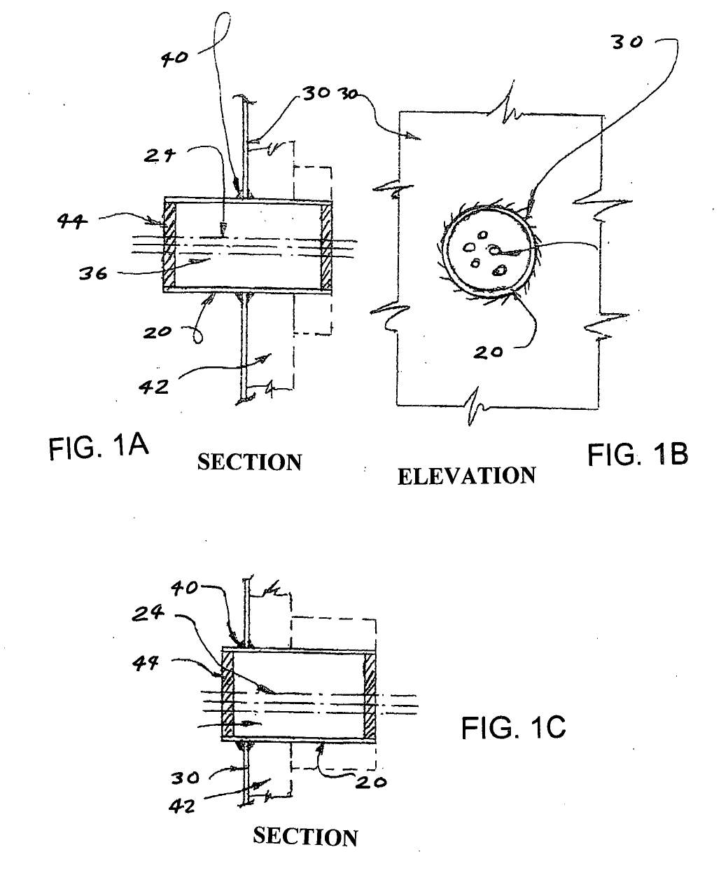

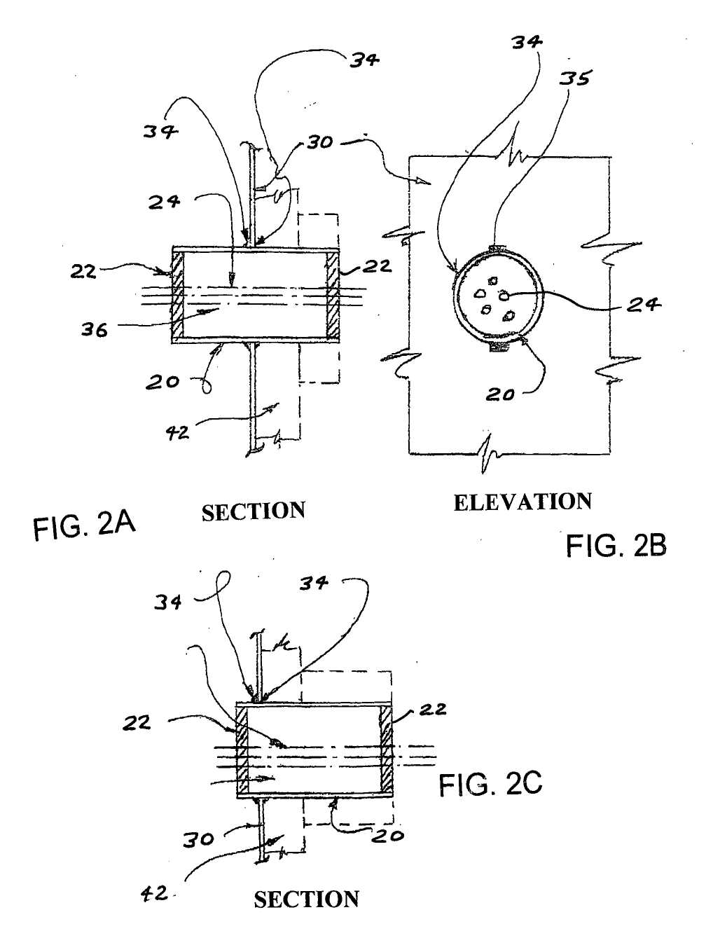

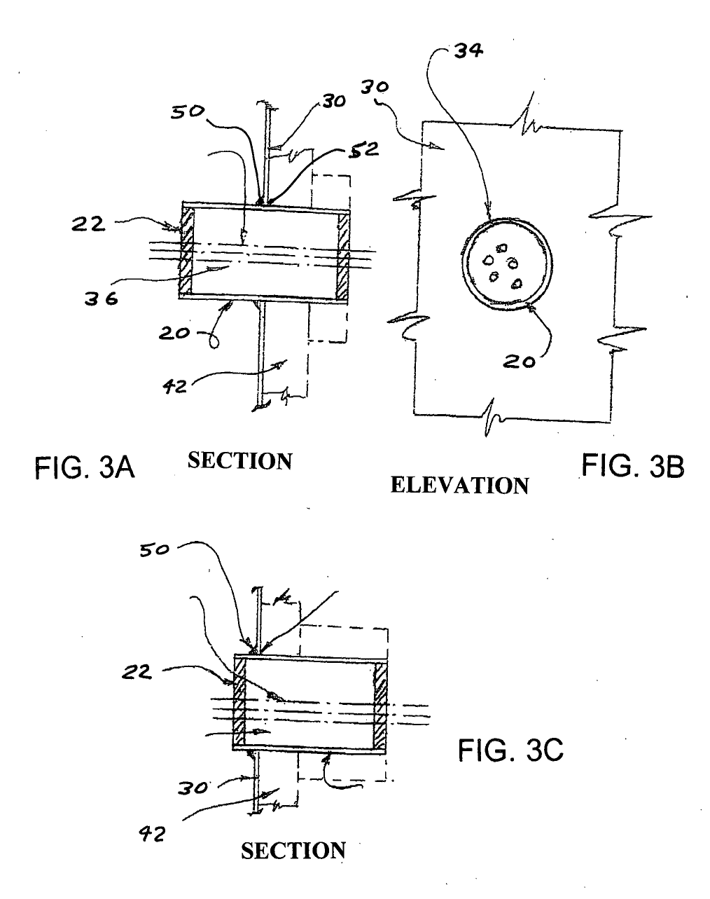

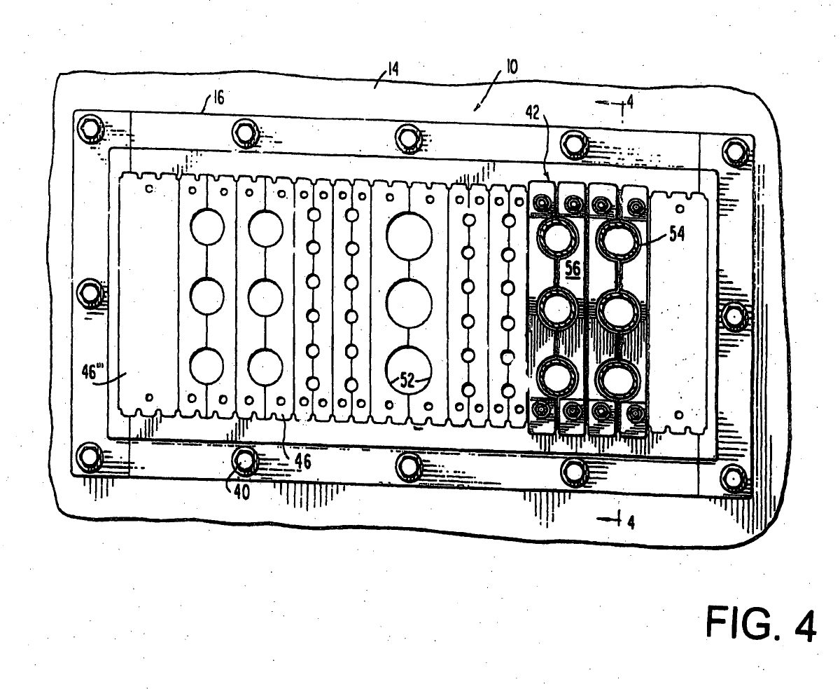

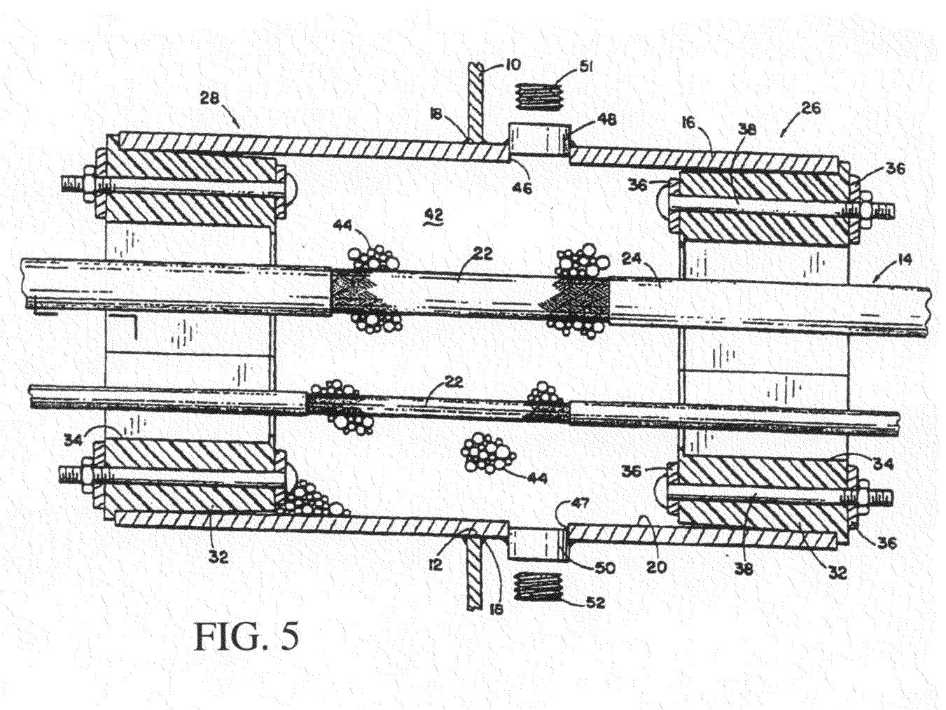

Preferred embodiments of the present invention are shown in FIGS. 2A-2C and 3A-3C. These drawings show bulkhead penetrations that are very similar to the prior art penetration shown in FIGS. 1A-1C and described in the background section. The reader should note that this prior art bulkhead penetration is a much simpler basic design than the penetrations described in the prior art patents referred to in the Background section and shown in FIGS. 4 and 5. The penetration is sealed at both ends of sleeve 20 by a silicon sealant 22 which can be applied in a pasty form but cures quickly to seal the penetration around the cables and/or pipes 24 that penetrate through the bulkhead penetration. However, the silicon sealant is easily dug out with a simple tool such as a knife so that the cables and/or piping can be replaced or repaired. The main problem with the prior art bulkhead penetration shown in FIGS. 1A-1C is that the sleeve 20 must be welded to the bulkhead with continuous welds 26 and 28 on both sides of the bulkhead 30 to provide for an airtight seal between compartments separated by the bulkhead. These two continuous welds require about several hours to make at a typical cost of about $50 per hour.

### First Preferred Embodiment

A first preferred embodiment of the present invention is shown in FIGS. 2A-2E. This penetration is very similar to the prior art penetration shown in FIGS. 1A-1C. The penetration is sealed at both ends of sleeve 20 by a silicon sealant seal 22 which can be applied in a fluid form but hardens quickly to seal the penetration around the cables and/or pipes 24 that penetrate through the bulkhead penetration. The important difference is that the sleeve is only tack welded preferable with four equally spaced tack welds. To provide the seal between the compartments a high temperature sealant is applied to around the sleeve between the sleeve and the bulkhead on both sides of the bulkhead as shown in FIGS. 2A-2C.

During installation, the sleeve is preferably tack welded with four tack welds as explained above. Preferably the sleeve is comprised of the same material as the bulkhead. The pipes and cables 24 are then installed through the sleeve. A silicate blanket is then stuffed into the cavity surrounding the pipes and or cables. Silicon sealant is the applied to one side of the seal and allowed to harden. The process is repeated on the other side of the bulkhead assuring the the cavity is bounded by the two silicone sealant seals 22. After the first sealant has cured sufficiently on the first side, additional silicate blanket material may be inserted to assure a dense packing of the cavity before the seal is applied to the other side. A density in the range of about 96 kg/m³ is recommended. Then the silicone sealant is applied to the other side to provide the other silicon sealant seal. Next high temperature silicone sealant is applied at the intersection of sleeve 20 with bulkhead 30 on both sides of the bulkhead completely around sleeve 20 to produce two sleeve-bulkhead seals 34 complete the sealing of the penetration. Applicant recommends the same sealant for seals 22 and seals 34 as described in detail in a following section

After the sealant has hardened the penetration should be tested as required by regulatory bodies. Typical test that are recommended are a water hose test or an air test could be used to verify tightness of the penetration. Also soap and water tests could be used with fan to produce a small pressure differential. The present invention is not recommended where large heads of water is anticipated on the bulkheads such as those forming tank boundaries.

### Second Preferred Embodiment

A second preferred embodiment of the present invention is exactly like the first preferred embodiment except the tack welds are replaced by a continuous weld on one side only of the bulkhead. The other side is sealed with high temperature sealant. Applicant has shown that the seal provided by the high temperature sealant is superior to the continuous weld in providing a seal between sleeves and bulkheads. This embodiment will not provide all of the savings provided by the first embodiment but will provide a better seal as compare to the FIGS. 1A-1C prior art penetration at no comprise in safety.

### Details of the Silicate Blanket

In preferred embodiments the silicate blanket meets the following specifications. The blanket material should have high handling strength, must be non-combustible, very flexible, easily cut and simple to install. A recommended blanket material is FireMaster Marine Plus Blanket available from Thermal Ceramics with offices in Augusta, Ga. At a thickness of 35 mm its R value is about 1.09 mK/W. At a density of 96 kg/m³ its thermal conductivity at 600 degrees C., is about 0.14 W/mK.

### Details of the High Temperature Sealant

In preferred embodiments the high temperature sealant meets the following specifications. Its chemical type is oxime silicone. In its uncured state it is a grey past and requires no mixing. It cures in air at room temperature. It cures to tack free condition in less than 30 minutes and to about 50% of full cure strength in about two days. It is fully cured in about 14 days. Its shear strength at a 0.5 mm gap between grit blasted mild steel is about 1.3 to 2.1 N/mm². Between aluminum it is about 0.1 to 0.7 mm². A preferred sealant that complies with these specifications is model Loctite 5699 available from Henkel Corporation with offices in Cleveland Ohio. This sealant is preferred for the seals 22 as well as seals 34 as stated above.

### Advantages of the Present Invention

While other blanket and sealant systems have been in the marketplace for many years what differentiates this system is a) the method of attaching the sleeve to the bulkhead and b) the components used in the proposed system perform at a higher level than those currently available. Also the high temperature sealant can be applied when sealing the transit thereby reducing the overall cost of the transit. Another important advantage is the silicon sealant seals 22 can be easily removed by simply digging them out with a simple tool such as a carving knife. Also sleeve to bulkhead seals 34 can be easily removed with a similar tool to permit the sleeve to be easily replaced by then removing the four tack welds as in the first preferred embodiment or the one side only continuous weld as in the second preferred embodiment.

### Variations

While the present invention has been described in terms of preferred embodiments, persons skilled in the art will recognize that many variations are possible within the general scope of the invention which is to be determined by the appended claims.

What is claimed is:

1. A fireproof bulkhead penetration comprising:
A) a sleeve defining two ends extending through and fixed to close fitting aperture in the bulkhead,
B) one or more cables and/or pipes extending through the sleeve,
C) a high-temperature blanket surrounding the one or more cables and/or pipes,
D) high-temperature sealant seals surrounding the one or more cables and/or pipes at both ends of said sleeve providing an air-tight, gas-tight, smoke-tight and water-tight seal of the sleeve,
E) high-temperature sealant seals surrounding the sleeve providing an air-tight, gas-tight, smoke-tight and water-tight seal of the bulkhead penetration.

2. The bulkhead penetration as in claim 1 wherein the sleeve is a cylindrical pipe section.

3. The bulkhead penetration as in claim 1 wherein the high-temperature blanket is comprised of silicate.

4. The bulkhead penetration as in claim 1 wherein the high-temperature blanket is non-combustible, very flexible and easily cut.

5. The bulkhead penetration as in claim 3 wherein the high-temperature blanket is non-combustible, very flexible and easily cut.

6. The bulkhead penetration as in claim 1 wherein the high-temperature sealant seals at both ends of said sleeve are comprised of a silicone material.

7. The bulkhead penetration as in claim 1 wherein the high-temperature sealant seals at both ends of said sleeve are comprised of oxime silicone.

8. The bulkhead penetration as in claim 1 wherein the high-temperature sealant seals surrounding said sleeve are comprised of a silicone material.

9. The bulkhead penetration as in claim 1 wherein the high-temperature sealant seals surrounding said sleeve are comprised of oxime silicone.
